(19) United States
(12) Patent Application Publication
(10) Pub. No.: US 2005/0031312 A1
(43) Pub. Date: Feb. 10, 2005

(54) Method and apparatus for signal reproduction

(76) Inventors: Tomoko Matsui, Osaka (JP); Ryouji Yamaguchi, Kyoto (JP); Tadashi Shibata, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/895,377

(22) Filed: Jul. 21, 2004

(30) Foreign Application Priority Data
Jul. 22, 2003 (JP) 2003-277855

(51) Int. Cl. H04N 5/76; H04N 5/781

(52) U.S. Cl. 386/98; 386/125

(57) ABSTRACT

This invention provides a method and apparatus for signal reproduction that can simultaneously reproduce N (N≧2) signals which are previously multiplexed, and simultaneously reproduce N independent signals. This apparatus selectively inputs the independent N coded signals in time division, adds the corresponding stream information to the selected input signal among N kinds of stream information for identifying the input signals, detects the stream information from the respective input signal, decodes the respective input signal by a decoding method corresponding to the respective input signal, which is decided based on the detected stream information, and outputs the decoded signal.

### FIELD OF THE INVENTION

The present invention relates to methods and apparatus for signal reproduction and, more particularly, to a method and apparatus for simultaneously reproducing plural signals which include arbitrary video or audio signals.

### BACKGROUND OF THE INVENTION

Video or audio signals are recorded as compressed or uncompressed digital signals on a storage medium, such as an optical disc, a magnetic disc, and a semiconductor memory. An operation of a decoder in a conventional signal reproduction apparatus that reproduces signals which are recorded on such storage medium will be described, with reference to FIGS. 10 and 11.

FIG. 10 is a block diagram illustrating a decoder of a conventional signal reproduction apparatus.

A decoder 900 comprises a data division unit 902 for dividing an input signal into a video signal and an audio signal in accordance with input signal information from outside; a video buffer 903 for storing the video signal from the data division unit 902; an audio buffer 904 for storing the audio signal from the data division unit 902; a video decoding unit 905 for decoding the video signal that is stored in the video buffer 903; an audio decoding unit 906 for decoding the audio signal that is stored in the audio buffer 904; a video output unit 907 for outputting the video signal that has been decoded by the video decoding unit 905; and an audio output unit 908 for outputting the audio signal that has bee decoded by the audio decoding unit 906.

FIGS. 11(1) to 11(3) are diagrams schematically showing examples of data sequences of input signals which are inputted to the decoder 900. There are data sequences as shown in FIG. 11(1) to 11(3), and input signal information indicating the type of a data sequence is given to the decoder 900 from the outside.

Hereinafter, the operation of the decoder will be described.

Initially, the description is given of a case where a video signal as shown in FIG. 11(1) is inputted to the decoder 900.

In this case, the decoder 900 is notified with the input signal information that a video elementary stream is inputted. The data division unit 902 outputs the entire input signal to the video decoding unit 905. The video decoding unit 905 decodes the input signal and outputs the decoded signal to the video output unit 907. The decoded video signal is outputted from the video output unit 907. That is, only the video signal is outputted from the decoder 900.

Next, a case where an audio signal as shown in FIG. 11(2) is inputted to the decoder 900 is described.

In this case, the decoder 900 is notified with the input signal information that an audio elementary stream is inputted. The data division unit 902 outputs the entire input signal to the audio decoding unit 906. The audio decoding unit 906 decodes the input signal and outputs the decoded signal to the audio output unit 908. The decoded audio signal is outputted from the audio output unit 908. That is, only the audio signal is outputted from the decoder 900.

Next, a case where a signal in which a video signal and an audio signal are multiplexed as shown in FIG. 11(3) is inputted to the decoder 900 is described.

In this case, the decoder 900 is notified with the input signal information that a multiplexed stream is inputted thereto. The data division unit 902 divides the input signal into the video signal and the audio signal, and outputs the video signal to the video decoding unit 905 and the audio signal to the audio decoding unit 906, respectively. For example, in the case of an MPEG-system stream, the video and audio signals are divided into units called packs, and multiplexed. The respective pack starts from a pack header. The data division unit 902 judges whether the pack is a video signal or an audio signal, on the basis of the pack header. The video decoding unit 905 and the audio decoding unit 906 decode the input signal, and output the decoded signal to the video output unit 907 and the audio output unit 908, respectively. The decoded video signal is outputted from the video output unit 907, and the decoded audio signal is outputted from the audio output unit 908, respectively. That is, the video signal and the audio signal are simultaneously reproduced and outputted.

As described above, the conventional signal reproduction apparatus can simultaneously reproduce audio and video only in a case of reproducing a system stream in which the video signal and the audio signal are previously multiplexed, and this apparatus cannot simultaneously reproduce N pieces of signals (N≧2) when these signals are not previously multiplexed.

In addition, as a method of simultaneously reproducing N pieces of signals (N≧2), Japanese Published Patent Application No. Hei.11-177934 (hereinafter, referred to as Document 1) suggests a reproduction method including independent video and audio decoders.

As described above, the conventional signal reproduction apparatus cannot simultaneously reproduce N pieces (N≧2) of signals when these signals are not previously multiplexed. That is, it is impossible to simultaneously reproduce independent audio and video signals.

Further, when the independent decoders are provided as suggested by the Document 1, N pieces of signals which are previously multiplexed cannot be reproduced simultaneously.

### SUMMARY OF THE INVENTION

The present invention provides a signal reproduction method and a signal reproduction apparatus which can simultaneously reproduce N pieces (N≧2) of signals which are previously multiplexed, and simultaneously reproduce independent N pieces of signals.

Other objects and advantages of the invention will become apparent from the detailed description that follows. The detailed description and specific embodiments described are provided only for illustration since various additions and modifications within the spirit and scope of the invention will be apparent to those of skill in the art from the detailed description.

According to a 1st aspect of the present invention, there is provided a signal reproduction method for reproducing a multiplexed signal in which N (N≧2) pieces of coded signals are multiplexed or one of the N pieces of coded signals, by decoding the same, comprising: switching among the independent N pieces of coded signals in time division to select one of the signals; adding, to the respective input signal that has been selected in time division, stream information corresponding to the selected input signal among N kinds of stream information for identifying the input signals; detecting the stream information of the respective input signal from the respective input signal to which the stream information has been added; decoding the respective input signal by a decoding method corresponding to the respective input signal, which is decided in accordance with the detected stream information; and outputting the decoded input signal. Therefore, it is possible to simultaneously reproduce N pieces of signals which are previously multiplexed, as well as simultaneously reproduce independent N pieces of signals.

According to a 2nd aspect of the present invention, in the signal reproduction method of the 1st aspect, the N pieces of input signals are video signals of still pictures or moving pictures. Therefore, it is possible to simultaneously reproduce independent N pieces of video signals.

According to a 3rd aspect of the present invention, in the signal reproduction method of the 1st aspect, the N pieces of input signals are audio signals. Therefore, it is possible to simultaneously reproduce independent N pieces of audio signals.

According to a 4th aspect of the present invention, in the signal reproduction method of the 1st aspect, the N pieces of input signals include at least one video signal of a still or moving picture and at least one audio signal. Therefore, it is possible to simultaneously reproduce independent N pieces of signals comprising a video signal and an audio signal.

According to a 5th aspect of the present invention, in the signal reproduction method of the 1st aspect, the switching among the input signals is performed for selecting the next input signal, after a predetermined amount of data of a selected input signal have been inputted. Therefore, it is possible to ensure input of N pieces of signals.

According to a 6th aspect of the present invention, in the signal reproduction method of the 5th aspect, the predetermined data amount is decided based on a unit of access to a storage medium on which the selected input signal is recorded, and is an amount of data which are read by a predetermined number of accesses. Therefore, it is possible to ensure input of N pieces of signals.

According to a 7th aspect of the present invention, in the signal reproduction method of the 6th aspect, the storage medium is any of an optical disc, a magneto-optical disc, a magnetic disc, and a semiconductor memory. Therefore, it is possible to simultaneously reproduce independent N pieces of input signals regardless of the type of a medium on which the input signals are recorded.

According to an 8th aspect of the present invention, in the signal reproduction method of the 7th aspect, the switching among the N pieces of input signals is performed by reading the respective N pieces of input signals which are recorded on the storage medium, in time division. Therefore, it is possible to simultaneously output independent N pieces of signals which are recorded on a storage medium.

According to a 9th aspect of the present invention, in the signal reproduction method of the 5th aspect, the N pieces of input signals are inputted from outside, and the predetermined data amount is decided at a multiple of a data amount of an input packet. Therefore, it is possible to simultaneously output independent N pieces of signals which are inputted from outside.

According to a 10th aspect of the present invention, in the signal reproduction method of the 5th aspect, the predetermined data amount is decided for the respective selected input signal, and the data amount ensures consecutive reproduction or reproduction in a predetermined time period of the selected input signal. Therefore, it is possible to ensure consecutive reproduction of the selected input signal.

According to an 11th aspect of the present invention, in the signal reproduction method of the 1st aspect, the input signals are switched every predetermined time. Therefore, it is possible to ensure the input of N pieces of signals.

According to a 12th aspect of the present invention, in the signal reproduction method of the 1st aspect, the stream information is information indicating whether the input signal is a video signal or an audio signal. Therefore, it is possible to simultaneously reproduce independent N pieces of video or audio signals.

According to a 13th aspect of the present invention, in the signal reproduction method of the 1st aspect, the stream information is information indicating a coding method of the input signal. Therefore, it is possible to simultaneously reproduce independent N pieces of signals.

According to a 14th aspect of the present invention, in the signal reproduction method of the 1st aspect, the stream information includes time information indicating an output timing of the input signal. Therefore, it is possible to synchronously reproduce signals which are independently recorded.

According to a 15th aspect of the present invention, in the signal reproduction method of the 1st aspect, when only one of the N pieces of coded signals or a previously-multiplexed signal comprising N pieces of signals is inputted, the signal is decoded without the stream information being added thereto. Therefore, it is possible to reproduce only one signal or previously-multiplexed N pieces of signals.

According to a 16th aspect of the present invention, there is provided a signal reproduction apparatus that reproduces a multiplexed signal in which N pieces (N≧2) of coded signals are multiplexed or one of the N pieces of coded signals, by decoding the same, comprising: a signal switching unit for switching among the independent N pieces of coded signals in time division in accordance with a control signal from a decoder control unit, to select one of the signals; a stream information addition unit for adding, to the respective input signal that has been selected in time division by the signal switching unit, stream information corresponding to the selected input signal among N kinds of stream information for identifying the input signals, in accordance with an identification signal from a decoder control unit; a data division unit for detecting the stream information of the respective input signal to which the stream information has been added by the stream information addition unit, and dividing the respective input signal to decode the input signal by a decoding method that is decided in accordance with the detected stream information; N decoding units for decoding the respective divided input signals which are outputted from the data division unit by the corresponding decoding methods, respectively; N output units for outputting decoded signals which are decoded by the N decoding units, respectively; and a decoder control unit for controlling the signal switching unit and the stream information addition unit as well as outputting, to the data division unit, input signal information indicating which data sequence is inputted to the data division unit. Therefore, it is possible to simultaneously reproduce N pieces of signals which are previously multiplexed, as well as simultaneously reproduce independent N pieces of signals.

According to a 17th aspect of the present invention, in the signal reproduction apparatus of the 16th aspect, the N pieces of input signals are video signals of still pictures or moving pictures. Therefore, it is possible to simultaneously reproduce independent N pieces of video signals.

According to an 18th aspect of the present invention, in the signal reproduction apparatus of the 16th aspect, the N pieces of input signals are audio signals. Therefore, it is possible to simultaneously reproduce independent N pieces of audio signals.

According to a 19th aspect of the present invention, in the signal reproduction apparatus of the 16th aspect, the N pieces of input signals includes at least one video signal of a still or moving picture and at least one audio signal. Therefore, it is possible to simultaneously reproduce independent N pieces of signals comprising video signals and audio signals.

According to a 20th aspect of the present invention, in the signal reproduction apparatus of the 16th aspect, the decoder control unit controls the signal switching unit for selecting the next input signal, after a predetermined amount of data of a selected input signal have been inputted. Therefore, it is possible to ensure input of N pieces of signals.

According to a 21st aspect of the present invention, in the signal reproduction apparatus of the 20th aspect, the predetermined data amount is decided based on a unit of access to a storage medium on which the selected input signal is recorded, and is an amount of data which are read by a predetermined number of accesses. Therefore, it is possible to ensure input of N pieces of signals.

According to a 22nd aspect of the present invention, in the signal reproduction apparatus of the 21st aspect, the storage medium is any of an optical disc, amagneto-optical disc, amagnetic disc, and a semiconductor memory. Therefore, it is possible to simultaneously reproduce independent N pieces of input signals regardless of the type of a medium on which the input signals are recorded.

According to a 23rd aspect of the present invention, in the signal reproduction apparatus of the 22nd aspect, the signal switching unit reads the respective N pieces of input signals which are recorded on the storage medium, in time division. Therefore, it is possible to simultaneously output independent N pieces of signals which are recorded on a storage medium.

According to a 24th aspect of the present invention, in the signal reproduction apparatus of the 21st aspect, the N pieces of input signals are inputted from outside, and the predetermined data amount is decided at a multiple of a data amount of an input packet. Therefore, it is possible to simultaneously output independent N pieces of signals which are inputted from outside.

According to a 25th aspect of the present invention, in the signal reproduction apparatus of the 21st aspect, the predetermined data amount is decided for the respective selected input signal, and the data amount ensures consecutive reproduction or reproduction in a predetermined time period of the selected input signal. Therefore, it is possible to ensure consecutive reproduction of the selective input signal.

According to a 26th aspect of the present invention, in the signal reproduction apparatus of the 16th aspect, the decoder control unit controls the signal switching unit for switching among the input signals every predetermined time. Therefore, it is possible to ensure input of N pieces of signals.

According to a 27th aspect of the present invention, in the signal reproduction apparatus of the 16th aspect, the stream information is information indicating whether the input signal is a video signal or an audio signal. Therefore, it is possible to simultaneously reproduce independent N pieces of video or audio signals.

According to a 28th aspect of the present invention, in the signal reproduction apparatus of the 16th aspect, the stream information is information indicating a coding method of the input signal. Therefore, it is possible to simultaneously reproduce independent N pieces of signals.

According to a 29th aspect of the present invention, in the signal reproduction apparatus of the 16th aspect, the stream information includes time information indicating an output timing to the output unit. Therefore, it is possible to synchronously reproduce signals which are independently recorded.

According to a 30th aspect of the present invention, in the signal reproduction apparatus of the 16th aspect, when only one of the N pieces of coded signals or a previously-multiplexed signal comprising N pieces of signals is inputted, the decoder control unit controls the signal switching unit for selectively inputting the input signal, and controls the stream information addition unit for outputting the selected signal to the data division unit without adding the stream information thereto, as well as outputs the input signal information indicating that the data sequence is only one signal or a previously-multiplexed signal, to the data division unit. Therefore, it is possible to reproduce only one signal or previously-multiplexed N pieces of signals.

### BRIEF DESCRIPTION OF THE DRAWINGS

FIG. 1 is a block diagram illustrating a signal reproduction apparatus according to a first embodiment of the present invention.

FIG. 2 is a diagram schematically showing a data sequence of a signal that is inputted to a switch of the signal reproduction apparatus according to the first embodiment.

FIG. 3 is a diagram for explaining an operation of a decoder control unit of the signal reproduction apparatus according to the first embodiment.

FIG. 4 is a diagram schematically showing a data sequence of a signal that is inputted to a decoder of the signal reproduction apparatus according to the first embodiment.

FIG. 5 is a diagram for explaining an operation of a data division unit of the signal reproduction apparatus according to the first embodiment.

FIG. 6 is a diagram showing an operation of the signal reproduction apparatus according to the first embodiment, from when an input signal is inputted to the apparatus to when a decoded signal is outputted therefrom.

FIG. 7 is a block diagram illustrating the signal reproduction apparatus according to the first embodiment in a case where an input signal that is recorded on an optical disc is read in time division.

FIGS. 8(1) and 8(2) are diagrams showing units of an input signal that is read by a disc reading unit in the signal reproduction apparatus as shown in FIG. 7.

FIG. 9 is a diagram showing an operation of the signal reproduction apparatus according to the first embodiment in a case of reproducing audio as background music while performing a slide show display of plural still pictures.

FIG. 10 is a block diagram illustrating a decoder of a conventional signal reproduction apparatus.

FIGS. 11(1) to 11(3) are diagrams schematically showing examples of data sequences of an input signal that is inputted to the decoder.

### DETAILED DESCRIPTION OF THE PREFERRED EMBODIMENTS

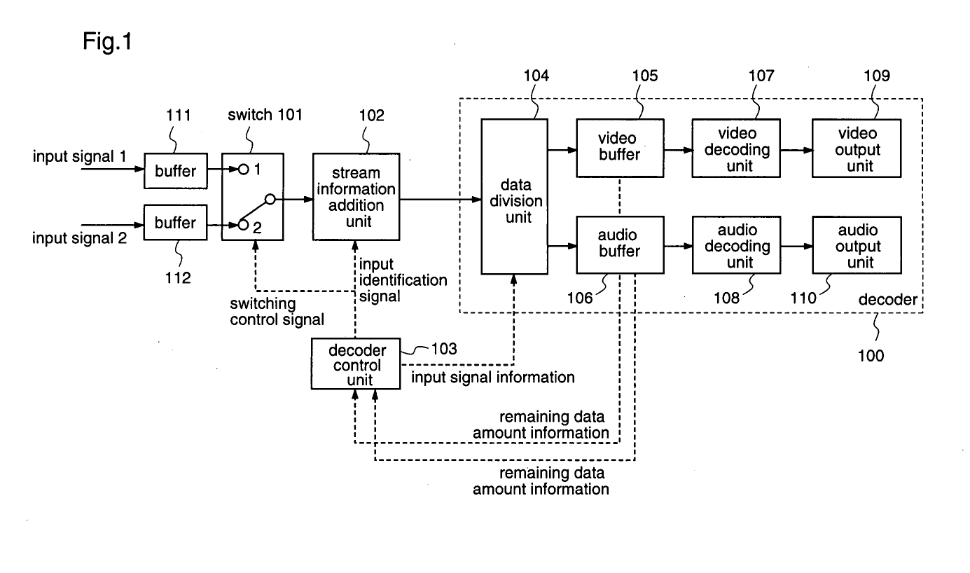

Hereinafter, an embodiment of the present invention will be described with reference to FIGS. 1 to 9.

[Embodiment 1]

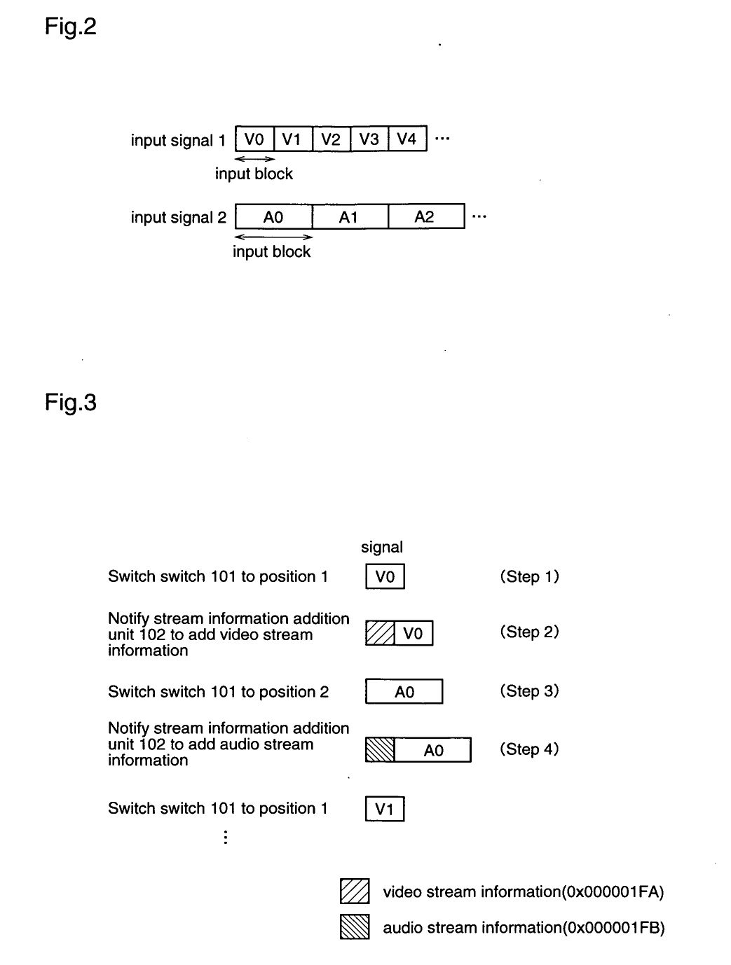

FIG. 1 is a block diagram illustrating a signal reproduction apparatus according to a first embodiment of the present invention. FIG. 2 is a diagram schematically showing examples of data sequences of a signal that is inputted to a switch of the signal reproduction apparatus according to the first embodiment.

As shown in FIG. 1, the signal reproduction apparatus according to the first embodiment includes a buffer 111 for storing an input signal 1, a buffer 112 for storing an input signal 2, a switch 101 for selecting the input signal 1 from the buffer 111 or the input signal 2 from the buffer 112, a stream information addition unit 102 that adds stream information for distinguishing between the input signal 1 and the input signal 2, to the respective input signal that is selected by the switch 101, a decoder 100 for decoding the signal to which the stream information has been added by the stream information addition unit 102, and a decoder control unit 103 for controlling the switch 101, the stream information addition unit 102, and the decoder 100. In the first embodiment, it is assumed that the input signal 1 is a video signal and the input signal 2 is an audio signal.

The decoder 100 comprises a data division unit 104 that receives the input signal to which the stream information has been added by the stream information addition unit 102, detects the added stream information of the input signal, and divides the respective input signal into a video signal and an audio signal so that the respective input signal is decoded by corresponding decoding methods which are decided in accordance with the stream information, respectively, a video buffer 105 that stores the video signal outputted from the data division unit 104, an audio buffer 106 that stores the audio signal outputted from the data division unit 104, a video decoding unit 107 that decodes the video signal, an audio decoding unit 108 that decodes the audio signal, a video output unit 109 that outputs the video signal decoded by the video decoding unit 107, and an audio output unit 110 that outputs the audio signal decoded by the audio decoding unit 108. In this first embodiment, the video decoding unit and the audio decoding unit are provided as the decoding units, while it is possible to decide the number and the types of the decoding units according to the input signals.

It is assumed here that input signals 1 and 2 as shown in FIG. 2 are inputted to the switch 101. These input signals 1 and 2 are switched in time division under the control of the decoder control unit 103. In addition, the input signals 1 and 2 are inputted with divided into input blocks of predetermined size. This size corresponds for example a size by which the data are read from a storage medium.

When issuing a switching control signal to the switch 101 for switching to the position 1 so as to select the input signal 1, the decoder control unit 103 issues an input identification signal to the stream information addition unit 102 for adding video stream information to the head of the signal from the switch 101. When issuing a switching control signal to the switch 101 for switching to the position 2 so as to select the input signal 2, the decoder control unit 103 issues an input identification signal to the stream information addition unit 102 for adding audio stream information to the head of the signal from the switch 101.

Hereinafter, the signal reproduction method will be described.

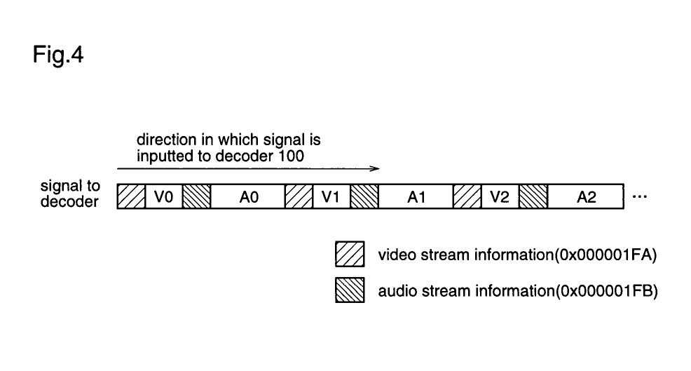

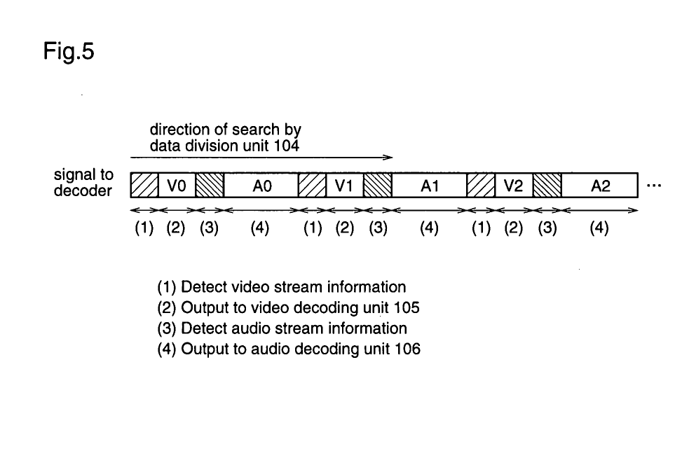

FIG. 3 is a diagram for explaining an operation of the decoder control unit of the signal reproduction apparatus according to the first embodiment, FIG. 4 is a diagram schematically showing an example of a data sequence of the signal that is inputted to the decoder of the signal reproduction apparatus according to the first embodiment, and FIG. 5 is a diagram for explaining an operation of the data division unit of the signal reproduction apparatus according to the first embodiment.

Initially, the operation of the decoder control unit 103 will be described with reference to FIG. 3.

An input block VO of the input signal 1 is inputted to the stream information addition unit 102 by switching the switch 101 to the position 1 under the control of the decoder control unit 103 (Step 1). The stream information addition unit 102 adds video stream information at the head of the file, and outputs the data to the decoder 100 (Step 2). An input block AO of the input signal 2 is inputted to the stream information addition unit 102 by switching the switch 101 to the position 2 under the control of the decoder control unit 103 (Step 3). The stream information addition unit 102 adds audio stream information at the head of the file, and outputs the data to the decoder 100 (Step 4). These processes are repeated until the input signals 1 and 2 end. An example of the signal that is inputted to the decoder 100, in which the video signal and the audio signal are multiplexed by these processes, is shown in FIG. 4. Here, it is assumed that the stream information which is added by the stream information addition unit 102 is a unique symbol being composed of 32 bits, and the video stream information is “0x000001FA” and the audio stream information is “0x000001FB”. Further, the decoder 100 is notified with the input signal information from the decoder control unit 103 that a signal to which the stream information has been added is inputted thereto.

Next, the operation of the data division unit 104 will be described with reference to FIG. 5. It is assumed here that a signal as shown in FIG. 4 is inputted to the decoder 100.

The data division unit 104 parses the input signal and stores the parsed signal in the video buffer 105 or the audio buffer 106.

The data division unit 104 parses the input signal from the head to search for “0x000001FA” or “0x000001FB” of 32 bits. When detecting “0x000001FA” (1), the data division unit 104 judges that the following signal V0 is a video signal. Then, the data division unit 104 outputs the signal V0 to the video buffer 105 (2) while starting again the search of “0x000001FA” or “0x000001FB”. When detecting “0x000001FB” (3), the data division unit 104 judges that the following signal A0 is an audio signal. Then, the data division unit 104 outputs the signal A0 to the audio buffer 106 (4) while starting again the search of “0x000001FA” or “0x000001FB”. The data division unit 104 continues these operations until the input will end.

The video decoding unit 107 decodes the input signal that is stored in the video buffer 105 to generate a decoded video signal, and outputs the decoded signal to the video output unit 109. Then, the video output unit 109 outputs the decoded video signal. Further, the video decoding unit 107 controls the video output timing and, when a one-frame output time has completed, it outputs a decoded video signal which will be displayed next, to the video output unit 109.

The audio decoding unit 108 decodes the data that is stored in the audio buffer 106 to generate a decoded audio signal, and outputs the.decoded signal to the audio output unit 110. Then, the audio output unit 110 outputs the decoded audio signal. Further, the audio decoding unit 108 controls the audio output timing and, when a one-frame output time has expired, it outputs the decoded audio signal which will be outputted next, to the audio output unit 110.

The decoder control unit 103 of the signal reproduction apparatus according to the first embodiment switches the switch 101 in time division, as well as controls the video buffer 105 or the audio buffer 106 in the subsequent stage so as not to cause overflow or underflow.

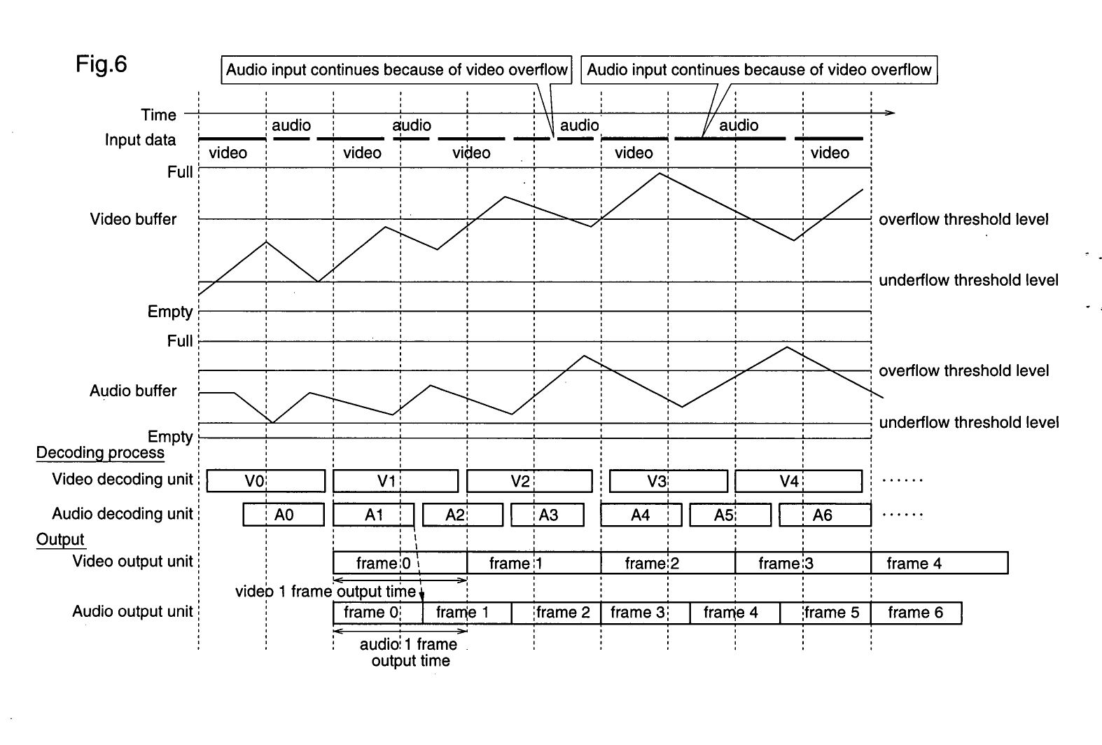

FIG. 6 shows an example of the operation from when an input signal is inputted to the apparatus to when a decoded signal is outputted therefrom. As shown in FIG. 6, for example when the amount of data in the video buffer 105 exceeds an overflow threshold level at a time of inputting the data to the video buffer 105, the decoder control unit 103 does not perform the input to the video buffer 105. In this case, when for example the amount of data in the audio buffer 106 does not exceed an overflow threshold level, the decoder control unit 103 continues the data input to the audio buffer 106.

Conversely, when the amount of remaining data in any of the buffers is less than the underf low threshold level, the decoder control unit 103 controls the switch 101 so as to input data preferentially to the buffer that is underflowing.

As described above, according to the signal reproduction method and apparatus of the first embodiment, the video signal and the audio signal are multiplexed and, at that time, unique stream information that enables to judge the type of the respective signal is inserted therein, and on the basis of the stream information, the video signal in the multiplexed signal is decoded by the video decoding unit and the audio signal therein is decoded by the audio decoding unit, respectively. Therefore, it is possible to simultaneously reproduce and output the independent video and audio signals.

The input signals 1 and 2 are inputted to the signal reproduction apparatus according to the first embodiment in time division, and the stream information addition unit 102 multiplexes these input signals with adding the stream information thereto, while it goes without saying that it can also process a signal comprising only a video signal, a signal comprising only an audio signal, or a signal in which a video signal and an audio signal are previously multiplexed, as shown in FIGS. 11(1), 11(2), and 11(3).

For example, when any of the above signals is inputted as the input signal 1, the decoder control unit 103 controls the switch 101 for selecting the input signal 1, and then the stream information addition unit 102 outputs the inputted signal as it is without adding stream information, to the decoder 100. When the input signal comprises only a video signal, the decoder 100 is notified with the input signal information from the decoder control unit 103 that a video elementary stream is inputted, then the video signal is decoded by the video decoding unit 107, and the decoded video signal is outputted from the video output unit 109. When the input signal comprises only the audio signal, the decoder 100 is notified with the input signal information from the decoder control unit 103 that an audio elementary stream is inputted, then the audio signal is decoded by the audio decoding unit 108, and the decoded audio signal is outputted from the audio output unit 110. When the video signal and the audio signal are previously multiplexed, the decoder 100 is notified with the input signal information from the decoder control unit 103 that a previously-multiplexed stream is inputted, and the data division unit 104 judges whether the respective input signal is a video signal or an audio signal on the basis of a pack header of the input signal. Then, the respective judged input signals are decoded by the video decoding unit 107 and the audio decoding unit 108, respectively, and the decoded video and audio signals are simultaneously outputted by the video output unit 109 and the audio output unit 110.

As described above, the signal reproduction apparatus according to the first embodiment can not only simultaneously reproduce plural signals which are multiplexed, with the stream information being added thereto by the stream addition unit, but also simultaneously reproduce previously-multiplexed plural signals.

In this first embodiment, when a signal comprising only one signal or a previously-multiplexed signal comprising plural signals is inputted, such signal is inputted to the decoder 100 without the stream information being added by the stream information addition unit 102. However, when such signal is to be inputted, it is also possible to input the signal directly to the decoder 100 without passing through the stream information addition unit 102.

According to the above-mentioned signal reproduction apparatus of the first embodiment, when independent video and audio signals are inputted through two channels of the input signal 1 and the input signal 2, respectively, the decoder control unit 103 controls the switch 101 for switching these signals in time division, the stream information addition unit 102 adds the corresponding stream information to the respective signal, and the data division unit 104 divides the respective input signal so as to decode the input signal by a decoding method corresponding to the stream information added to the respective input signal. Therefore, it is possible to simultaneously reproduce not only a previously-multiplexed signal but also independent N (N≧2) signals.

In this first embodiment, the descriptions have been given of the case of using “0x000001FA” and “0x000001fB” as the stream information. They are reserved headers which are selected from among those defined in MPEG system standards (ISO/IEC 13818-1). When these headers are employed, it is possible to prevent erroneous detection of stream information from the video signal or the audio signal, but the stream information is not limited to “0x000001FA” and “0x000001FB”.

Further, it is assumed in this first embodiment that the input signal is a video signal and an audio signal and that the decoding is performed by the video decoding unit and the audio decoding unit, respectively, but the present invention is not limited thereto. In addition, the case where two signals are inputted has been described in this first embodiment, while the same effect is obtained also in a case where N pieces (N≧2) of signals are inputted. In such cases, when the data division unit is made to detect N pieces of unique stream information, it is possible to simultaneously reproduce N pieces of input signals.

It is also possible to input a video signal which is compressed by a MPEG coding method, and a video signal of a still picture which is compressed by a JPEG coding method. In this case, a MPEG video decoder and a JPEG decoder are used as the decoding units. It is also possible to input two independent video signals that are compressed by the MPEG coding method. In this case, a MPEG video decoder is used as the decoding unit, and a control is performed so as to process these two signals in a time-divided manner. The same effect is obtained also in a case where plural audio signals are inputted. It is also possible that a video signal that is compressed by the MPEG coding method, a video signal of a still picture which is compressed by the JPEG coding method, and an audio signal are inputted. When the data division unit can detect stream information corresponding to the respective input signals, it is possible to simultaneously reproduce plural input signals regardless of the type of the input signal or the coding method.

In this first embodiment, the decoder control unit switches the switch in units of input block having a predetermined size. The predetermined size is decided based on a size of reading from a storage medium, while this size is not limited to this. For example, when an audio signal is included in the input signal, it is possible to decide the size of the input block so that the audio signal is outputted from the audio output unit without interruption. When audio is reproduced as background music while a slide show display of plural still pictures during a display time T is performed (these still pictures are reproduced in the order of still pictures 1, 2, . . . ), it is possible to decide the size of the respective input block so that the reproduction of the video signal will end at the display time T while the audio signal will be continuously reproduced. Further, it is also possible to switch the switch not according to the size of the input block but according to the time.

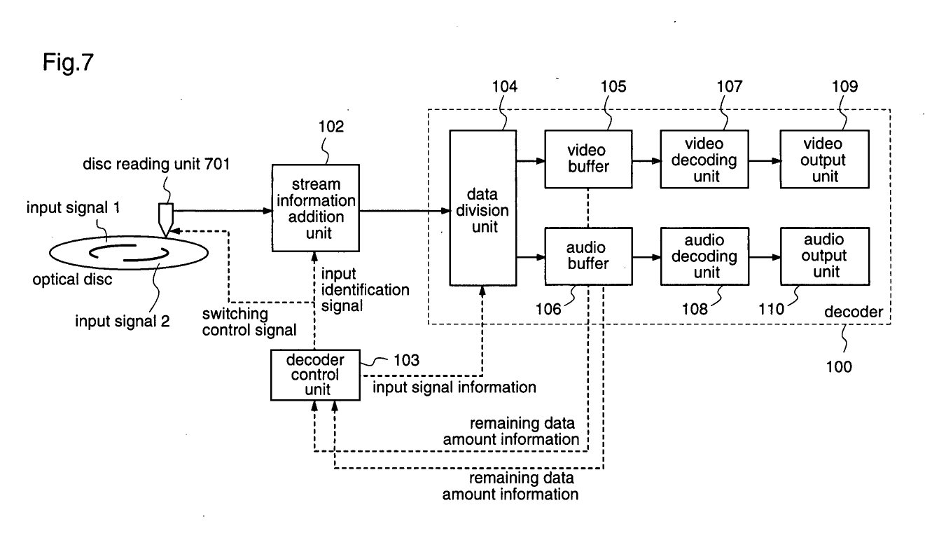

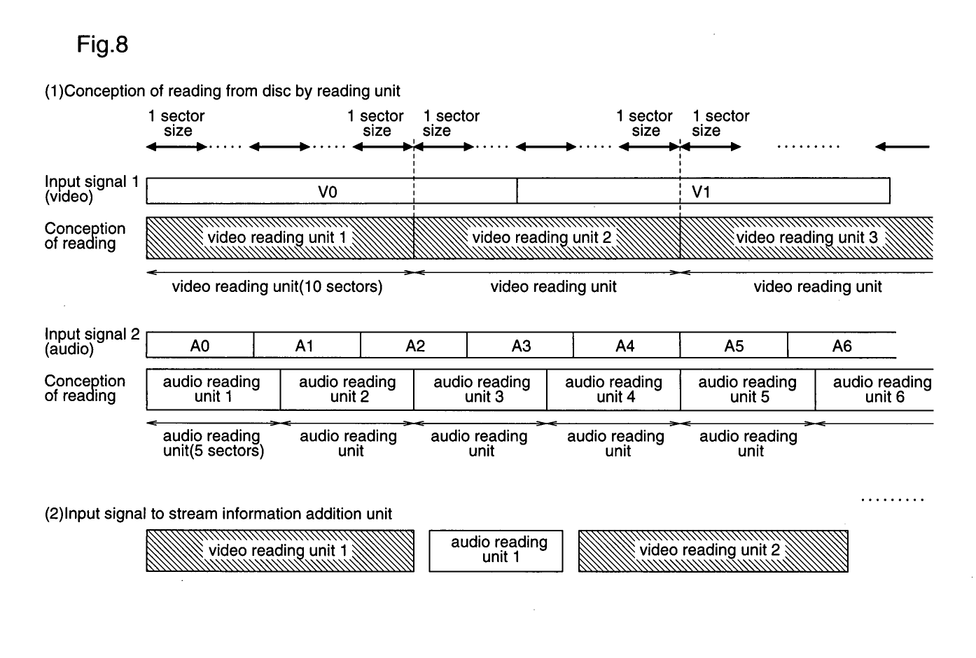

As the storage medium, it is possible to utilize any of an optical disc, a magneto-optical disc, a magnetic disc, and a semiconductor memory. For example, when an optical disc is used as the storage medium and any independent video and audio signals are to be simultaneously reproduced, a structure as shown in FIG. 7 may be employed. In this case, in place of selecting the input signal by the switch 101 as shown in FIG. 1, reading of data by a data reading unit 701 is performed in a time-divided manner under control of the decoder control unit, thereby selecting a signal to be inputted. Examples of signals that are reproduced from the optical disc are shown in FIGS. 8(1) and 8(2). The input signals 1 and 2 are switched in time division under control of the decoder control unit 103.

FIG. 8(1) is a diagram for explaining a reading unit of the input signal, and FIG. 8(2) is a diagram for explaining a signal sequence that is read from the optical disc and outputted to the stream information addition unit 102 by the disc reading unit 701.

On the optical disc, an input signal 1 and an input signal 2 are recorded. In this first embodiment, the input signal 1 is a video signal and the input signal 2 is an audio signal, and the optical disc is for example a CD (compact disc). The disc reading unit 701 moves up to a reading position in accordance with a control signal from the decoder control unit 103, and reads a predetermined amount of data of the signal from the optical disc.

As shown in FIG. 8(1), a signal is recorded on the optical disc, being divided in units called sectors. The disc reading unit 701 reads the data in a reading unit, which is composed of plural sectors. In FIG. 8, as the predetermined sizes, the reading unit of the video signal is composed of 10 sectors, and the reading unit of the audio signal is composed of 5 sectors. The reason why the reading size of the video signal is set at a larger value than the audio signal is because the data size of the video signal is larger than the audio signal. A signal sequence as shown in FIG. 8(2) is inputted to the stream information addition unit 102. The process of the stream information addition unit 102 and the following processes are the same as those described above.

The apparatus according to the first embodiment simultaneously reproduces independent N pieces of data which are inputted from the storage medium, while the present invention is effective also in cases where N pieces of input signals are independently inputted from outside. In this case, for example by using the same structure as shown in FIG. 1, the input signals are stored in the buffers 111 and 112, a unit of reading of the input signals is set at a multiple of the data amount of the input packet, and the N pieces of input signals are switched in time division by the decoder control unit 103.

In this first embodiment, the stream information for judging whether the signal is a video signal or an audio signal is utilized. However, when video signals which are coded by plural different coding methods are inputted as the input signals, information that enables to judge the coding method may be employed. It is also possible to add time information for deciding the output timing of the input signal to the stream information, in addition to the information for identifying between the video signal and the audio signal or the information for judging the coding method. For example, when the input signal comprises an audio signal and a video signal which are coded at a fixed rate, time information is added every predetermined size, and when the respective input signal is decoded by the corresponding decoding unit, the control is performed for outputting the decoded signal to the corresponding output unit in accordance with the time information which has been added to the stream information, thereby realizing a synchronous reproduction of the independent audio and video signals. In this case, a mechanism for controlling the video output unit and the audio output unit on the basis of the stream information must be additionally provided to the video decoding unit and the audio decoding unit.

A further description will be given of the case where audio is reproduced as background music while performing a slide show display of plural still pictures (the reproduction is performed in the order of still pictures 1, 2, . . . ). In the stream information of the first input block of the still picture 1, information of the display period T. of the frame is inserted.

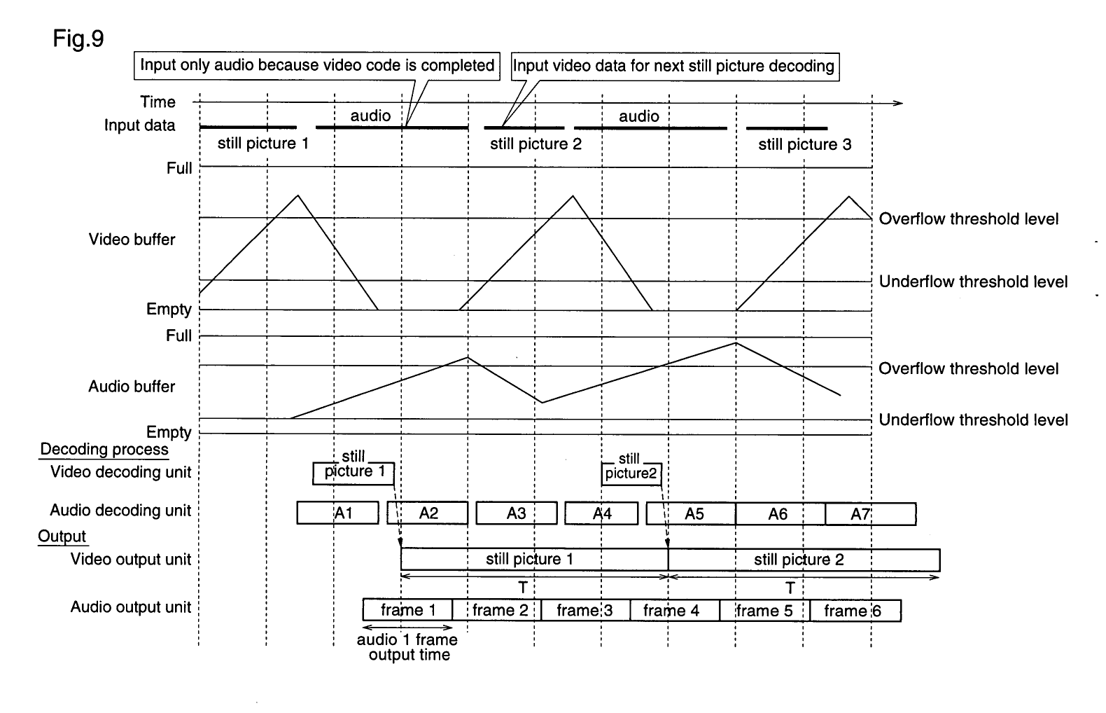

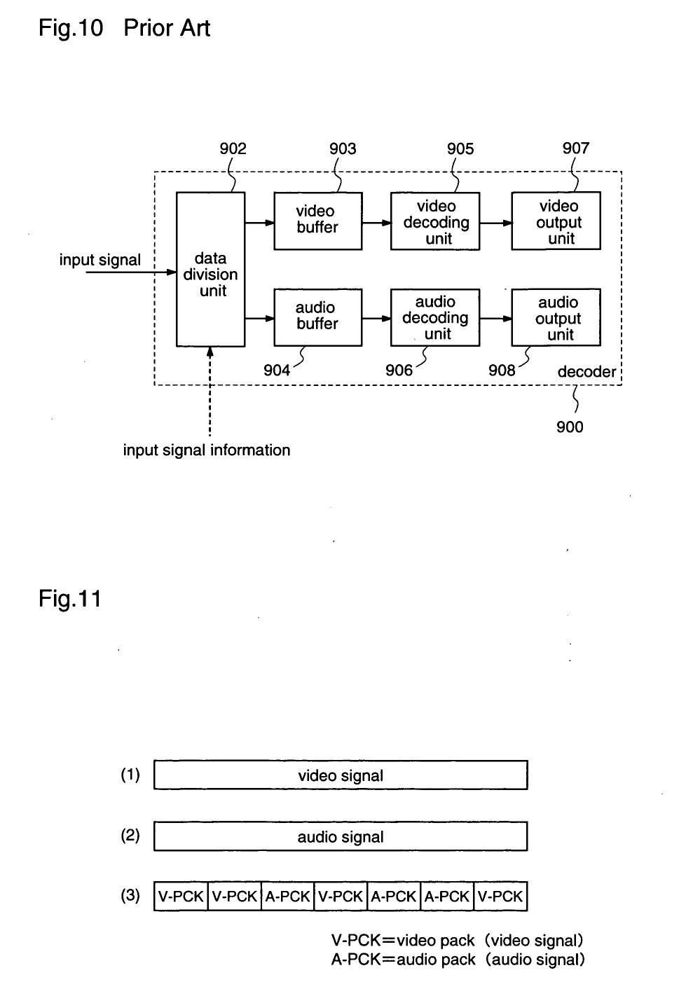

For example, as shown in the operation diagram of FIG. 9, the decoder control unit 103 initially inputs data of the still picture 1. The video decoding unit 107 decodes the still picture 1, and inputs the decoded data to the video output unit 109. Then, the still picture 1 is outputted from the video output unit 109. Next, the decoder control unit 103 preferentially inputs audio data. The audio decoding unit 108 decodes the audio data that is inputted to the buffer and outputs the decoded data. Further, the decoder control unit 103 performs data input of the still picture 2 before the display time T of the still picture 1 will end, and the video decoding unit 107 starts the decoding when the data is inputted to the video buffer 105. In the meantime, the video decoding unit 107 monitors the display time of the still picture 1, and when the display time has completed and there exists the still picture 2 which will be displayed next, it outputs the still picture 2 to the video output unit 109 to switch the display.

As described above, the signal reproduction method and apparatus according to the present invention is useful as a method and apparatus that reproduces digital signals such as video signals or audio signals which are recorded on an optical disc, a magneto-optical disc, a magnetic disc, a semiconductor memory, or the like.

1. A signal reproduction method for reproducing a multiplexed
signal in which N (N≧2) pieces of coded signals are multiplexed or one of the N pieces of coded signals, by decoding the same, comprising:
switching among the independent N pieces of coded signals in time division to select one of the signals;
adding, to the respective input signal that has been selected in time division, stream information corresponding to the selected input signal among N kinds of stream information for identifying the input signals;
detecting the stream information of the respective input signal from the respective input signal to which the stream information has been added;
decoding the respective input signal by a decoding method corresponding to the respective input signal, which is decided in accordance with the detected stream information; and
outputting the decoded input signal.

2. The signal reproduction method of claim 1 wherein
said N pieces of input signals are video signals of still pictures or moving pictures.

3. The signal reproduction method of claim 1 wherein
said N pieces of input signals are audio signals.

4. The signal reproduction method of claim 1 wherein
said N pieces of input signals include at least one video signal of a still or moving picture and at least one audio signal.

5. The signal reproduction method of claim 1 wherein
the switching among the input signals is performed for selecting the next input signal, after a predetermined amount of data of a selected input signal have been inputted.

6. The signal reproduction method of claim 5 wherein
said predetermined data amount is decided based on a unit of access to a storage medium on which the selected input signal is recorded, and is an amount of data which are read by a predetermined number of accesses.

7. The signal reproduction method of claim 6 wherein
the storage medium is any of an optical disc, a magneto-optical disc, a magnetic disc, and a semiconductor memory.

8. The signal reproduction method of claim 7 wherein
the switching among the N pieces of input signals is performed by reading the respective N pieces of input signals which are recorded on the storage medium, in time division.

9. The signal reproduction method of claim 5 wherein
said N pieces of input signals are inputted from outside, and
said predetermined data amount is decided at a multiple of a data amount of an input packet.

10. The signal reproduction method of claim 5 wherein
said predetermined data amount is decided for the respective selected input signal, and said data amount ensures consecutive reproduction or reproduction in a predetermined time period of the selected input signal.

11. The signal reproduction method of claim 1 wherein
said input signals are switched every predetermined time.

12. The signal reproduction method of claim 1 wherein
said stream information is information indicating whether the input signal is a video signal or an audio signal.

13. The signal reproduction method of claim 1 wherein
said stream information is information indicating a coding method of the input signal.

14. The signal reproduction method of claim 1 wherein
said stream information includes time information indicating an output timing of the input signal.

15. The signal reproduction method of claim 1 wherein
when only one of the N pieces of coded signals or a previously-multiplexed signal comprising N pieces of signals is inputted, the signal is decoded without the stream information being added thereto.

16. A signal reproduction apparatus that decodes a multiplexed signal in which N pieces (N≧2) of coded signals are multiplexed or one of the N pieces of coded signals, to reproduce the same, comprising:
a signal switching unit for switching among the independent N pieces of coded signals in time division in accordance with a control signal from a decoder control unit, to select one of the signals;
a stream information addition unit for adding, to the respective input signal that has been selected in time division by the signal switching unit, stream information corresponding to the selected input signal among N kinds of stream information for identifying the input signals, in accordance with an identification signal from a decoder control unit;
a data division unit for detecting the stream information of the respective input signal to which the stream information has been added by the stream information addition unit, and
dividing the respective input signal to decode the input signal by a decoding method that is decided in accordance with the detected stream information;
N decoding units for decoding the respective divided input signals which are outputted from the data division unit by the corresponding decoding methods, respectively;
N output units for outputting decoded signals which are decoded by the N decoding units, respectively; and
a decoder control unit for controlling the signal switching unit and the stream information addition unit as well as outputting, to the data division unit, input signal information indicating which data sequence is inputted to the data division unit.

17. The signal reproduction apparatus of claim 16 wherein
said N pieces of input signals are video signals of still pictures or moving pictures.

18. The signal reproduction apparatus of claim 16 wherein
said N pieces of input signals are audio signals.

19. The signal reproduction apparatus of claim 16 wherein
said N pieces of input signals includes at least one video signal of a still or moving picture and at least one audio signal.

20. The signal reproduction apparatus of claim 16 wherein
the decoder control unit controls the signal switching unit for selecting the next input signal, after a predetermined amount of data of a selected input signal have been inputted.

21. The signal reproduction apparatus of claim 20 wherein
said predetermined data amount is decided based on a unit of access to a storage medium on which the selected input signal is recorded, and is an amount of data which are read by a predetermined number of accesses.

22. The signal reproduction apparatus of claim 21 wherein
the storage medium is any of an optical disc, a magneto-optical disc, a magnetic disc, and a semiconductor memory.

23. The signal reproduction apparatus of claim 22 wherein
the signal switching unit reads the respective N pieces of input signals which are recorded on the storage medium, in time division.

24. The signal reproduction apparatus of claim 20 wherein
said N pieces of input signals are inputted from outside, and
said predetermined data amount is decided at a multiple of a data amount of an input packet.

25. The signal reproduction apparatus of claim 20 wherein
said predetermined data amount is decided for the respective selected input signal, and said data amount ensures consecutive reproduction or reproduction in a predetermined time period of the selected input signal.

26. The signal reproduction apparatus of claim 16 wherein
the decoder control unit controls the signal switching unit for switching among the input signals every predetermined time.

27. The signal reproduction apparatus of claim 16 wherein
said stream information is information indicating whether the input signal is a video signal or an audio signal.

28. The signal reproduction apparatus of claim 16 wherein
said stream information is information indicating a coding method of the input signal.

29. The signal reproduction apparatus of claim 16 wherein
said stream information includes time information indicating an output timing to the output unit.

30. The signal reproduction apparatus of claim 16 wherein
when only one of the N pieces of coded signals or a previously-multiplexed signal comprising N pieces of signals is inputted,
the decoder control unit controls the signal switching unit for selectively inputting the input signal, and controls the stream information addition unit for outputting the selected signal to the data division unit without adding the stream information thereto, as well as outputs the input signal information indicating that the data sequence is only one signal or a previously-multiplexed signal, to the data division unit.
